(19) United States
(12) Patent Application Publication
(10) Pub. No.: US 2014/0019286 A1
(43) Pub. Date: Jan. 16, 2014

(54) SYSTEMS, DEVICES AND METHODS FOR FACILITATING STRUCTURED SETTLEMENT TRANSACTIONS

(71) Applicant: Winning Bid, Inc., Spokane, WA (US)

(72) Inventors: Patrick Fannin, Spokane, WA (US); Michael Keese, Hayden, ID (US); Stephen Parker, Piedmont, CA (US)

(73) Assignee: Winning Bid, Inc., Spokane, WA (US)

(21) Appl. No.: 14/027,626

(22) Filed: Sep. 16, 2013

Related U.S. Application Data
(63) Continuation of application No. PCT/US2012/029669, filed on Mar. 19, 2012.
(60) Provisional application No. 61/453,569, filed on Mar. 17, 2011.

(51) Int. Cl. G06Q 20/24; G06Q 30/08

(52) U.S. Cl. CPC G06Q 20/24; G06Q 30/08
USPC 705/26.3

(57) ABSTRACT

In one embodiment, a structured settlement transaction information processing system, using the structured settlement transaction data, causes a bid item to be displayed at a first bidder interface and a second bidder interface. In one embodiment, the structured settlement transaction information processing system enables a first bidder to place a first bid on the bid item using the first bidder interface. In one embodiment, the structured settlement transaction information processing system enables a second bidder to place a second bid on the bid item using the second bidder interface. In one embodiment, the structured settlement transaction information processing system, based on at least one of the first bid and the second bid, provides a notification to at least one of the first bidder and the second bidder, the notification being indicative of an intention to sell the bid item.

### CROSS-REFERENCE

This application is a continuation of International Application No. PCT/US2012/029669, filed Mar. 19, 2012 which claims the benefit of priority to U.S. Provisional Patent Application Ser. No. 61/453,569, filed Mar. 17, 2011, the contents of each are hereby incorporated by reference in their entirety.

### FIELD

This disclosure relates generally to the field of structured settlements and in an embodiment to systems, devices and methods which enable users to conduct structured settlement transactions.

### BACKGROUND

A recipient of payments under a structured settlement payment plan receives a future payment or multiple payments according to a schedule. Some recipients of structured settlement payments desire to sell all or a portion of their future payment or payments for an immediate, one-time, lump sum of money. While there are presently entities and people willing to pay a lump-sum to such individuals in exchange for a transfer of some or all of an individual's future payment or payments, the transfer of structured settlement payments is cumbersome and the present market has a number of transparency problems that inhibits liquidating the right to future structured settlement payments.

### SUMMARY

The market for the sale of structured settlement payment plans is cumbersome because court approval is typically required to sell or transfer a structured settlement payment plan. Court approval can take months and cost thousands of dollars. Courts may not approve a transaction if the transaction does not meet various substantive standards or if the parties to the transaction do not follow governing court rules and procedures. This tends to limit the pool of potential purchasers to those who understand the laws governing the transfer of structured settlements, the likelihood of a court approving the transaction and who are otherwise willing to take the risk and advance the costs necessary to obtain court approval. Because the pool of potential purchasers is limited, they are able in many cases to purchase the future payment(s) for prices that allow for windfall profits or that are otherwise not favorable to the sellers.

This gap between the actual present value of the future payment(s) and the discounted price often being paid by purchasers creates the transparency issues referenced above. The purchasers often obtain from the seller the right to purchase the future payment(s) on their behalf “and/or their assignee.” The seller never knows who this assignee is or the amount of money the assignee is paying to be the assignee. Because the purchasers are able to secure the right to purchase structured settlement payment(s) at substantially decreased prices, and because they have the know-how to obtain court approval, they are able to immediately re-sell at a profit the right to purchase the payment stream to another investor; one who may not have the know-how or desire to go through the court approval process but nonetheless desires to purchase the future payment stream. This third-party becomes the assignee. The original purchaser does not actually purchase the structured settlement payment(s). Instead, that party locks the seller into selling at a discounted price, receives that sum of money plus additional money from an assignee and then obtains court approval of the transaction based on the original agreed upon price. In this circumstance, the so-called purchaser essentially acts as a broker or middleman. This broker cannot let the seller or assignee meet for fear that the two could cut the broker out of the transaction. Accordingly, the assignees' ability to fully investigate the transaction is somewhat limited and the sellers are left in the dark as to how much at least one ready, willing and able purchaser is willing to spend for their future payment(s). Additionally, in some instances, the broker, who is posing as the purchaser, may not have a willing assignee immediately available and must find one in order to fund the agreed to purchase price owed to the seller and to cover the broker's profit. Accordingly, the seller may have to wait for the broker to find the assignee. All the while, the broker may continue to pose, to the seller's ignorance, as the would-be purchaser—further adding to the transparency problem.

In turn, the cumbersome and opaque problems result in several systemic problems in the current structured settlement resale industry: structured settlement payments are difficult and expensive to liquidate Many recipients of structures settlement payments who would be willing to sell for a reasonable price have no place to turn and despite compelling, urgent or even emergent reasons for needing immediate cash, may be unwilling or unable to liquidate at the discount rates currently available in the present market. The present disclosure remedies these deficiencies in this market.

In one embodiment, a structured settlement transaction information processing system includes a processor and a memory device. In one embodiment, the memory device stores structured settlement transaction data and instructions which when executed by the processor, cause the processor to: (a) using the structured settlement transaction data, cause a bid item to be displayed at a first bidder interface and a second bidder interface; (b) enable a first bidder to place a first bid on the bid item using the first bidder interface, the first bid having a first minimum amount; (c) enable a second bidder to place a second bid on the bid item using the second bidder interface, the second bid having a second minimum amount; and (d) based on at least one of the first bid and the second bid, provide a notification to at least one of the first bidder and the second bidder, the notification being indicative of an intention to sell the bid item.

The structured settlement transaction information processing system, devices and method disclosed herein may enable a payment recipient to receive a higher price for selling his or her payment rights to a structured settlement.

Additional features and advantages are described herein, and will be apparent from the following Detailed Description and figures.

### BRIEF DESCRIPTION OF THE FIGURES

FIG. 1 is a high level block diagram of an example structured settlement transaction information processing system, according to an example embodiment of the present invention.

FIG. 2 is a detailed block diagram showing an example of a computing device, according to an example embodiment of the present invention.

FIG. 3 is a block diagram showing an example structured settlement transaction network structure, according to an example embodiment of the present invention.

FIG. 4 includes a flowchart illustrating an example process for facilitating a structured settlement transaction, according to an example embodiment of the present invention.

FIG. 5 is a block diagram showing an example data architecture, according to an example embodiment of the present invention.

FIG. 6 is a front view of one example embodiment of a display of an example structured settlement transaction information processing system.

### DETAILED DESCRIPTION

The present disclosure relates in general to a system for facilitating structured settlement transactions.

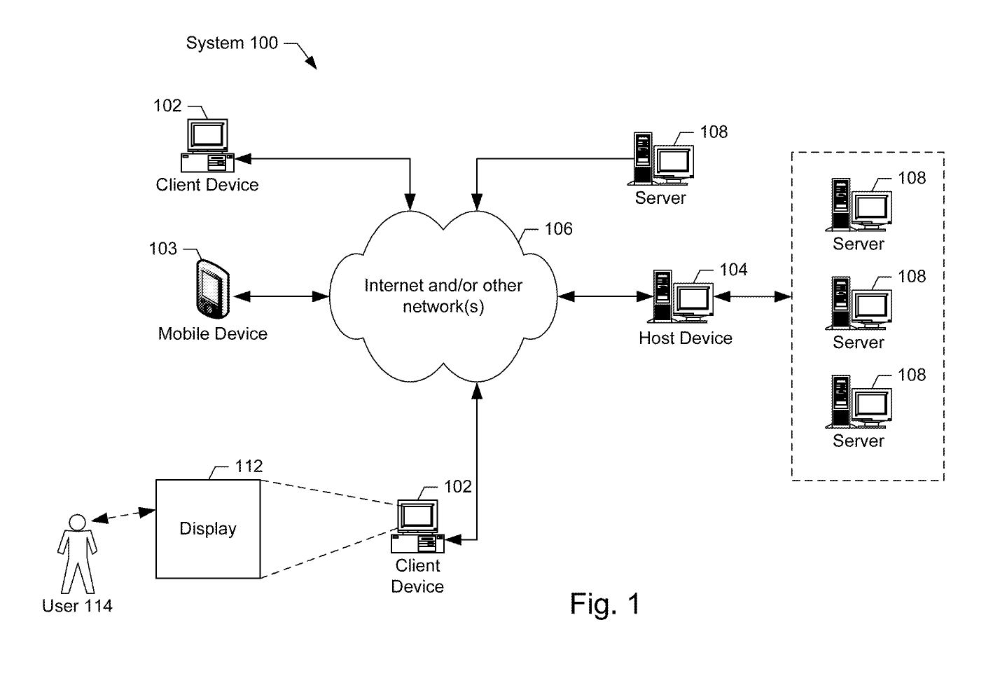

The present system may be readily realized in a network communications system. A high level block diagram of an example network communications system 100 is illustrated in FIG. 1. The illustrated system 100 includes one or more client devices 102, and one or more host devices 104. The system 100 may include a variety of client devices 102, such as desktop computers and the like, which typically include a display 112, which is a user display for providing information to users 114, and various interface elements as will be discussed in further detail below. A client device 102 may be a mobile device 103, which may be a cellular phone, a personal digital assistant, a laptop computer, a tablet computer, etc. The client devices 102 may communicate with the host device 104 via a connection to one or more communications channels 106 such as the Internet or some other data network, including, but not limited to, any suitable wide area network or local area network. It should be appreciated that any of the devices described herein may be directly connected to each other instead of over a network. Typically, one or more servers 108 may be part of the network communications system 100, and may communicate with host servers 104 and client devices 102.

One host device 104 may interact with a large number of users 114 at a plurality of different client devices 102. Accordingly, each host device 104 is typically a high end computer with a large storage capacity, one or more fast microprocessors, and one or more high speed network connections. Conversely, relative to a typical host device 104, each client device 102 typically includes less storage capacity, a single microprocessor, and a single network connection. It should be appreciated that a user 114 as described herein may include any person or entity which uses the presently disclosed system and may include a wide variety of parties. For example, as will be discussed in further detail below, users 114 of the presently disclosed system may include a payment recipient, a structured settlement obligor, a payor, an intermediary advisor, and/or a bidder.

Typically, host devices 104 and servers 108 store one or more of a plurality of files, programs, databases, and/or web pages in one or more memories for use by the client devices 102, and/or other host devices 104 or servers 108. A host device 104 or server 108 may be configured according to its particular operating system, applications, memory, hardware, etc., and may provide various options for managing the execution of the programs and applications, as well as various administrative tasks. A host device 104 or server may interact via one or more networks with one or more other host devices 104 or servers 108, which may be operated independently. For example, host devices 104 and servers 108 operated by a separate and distinct entities may interact together according to some agreed upon protocol.

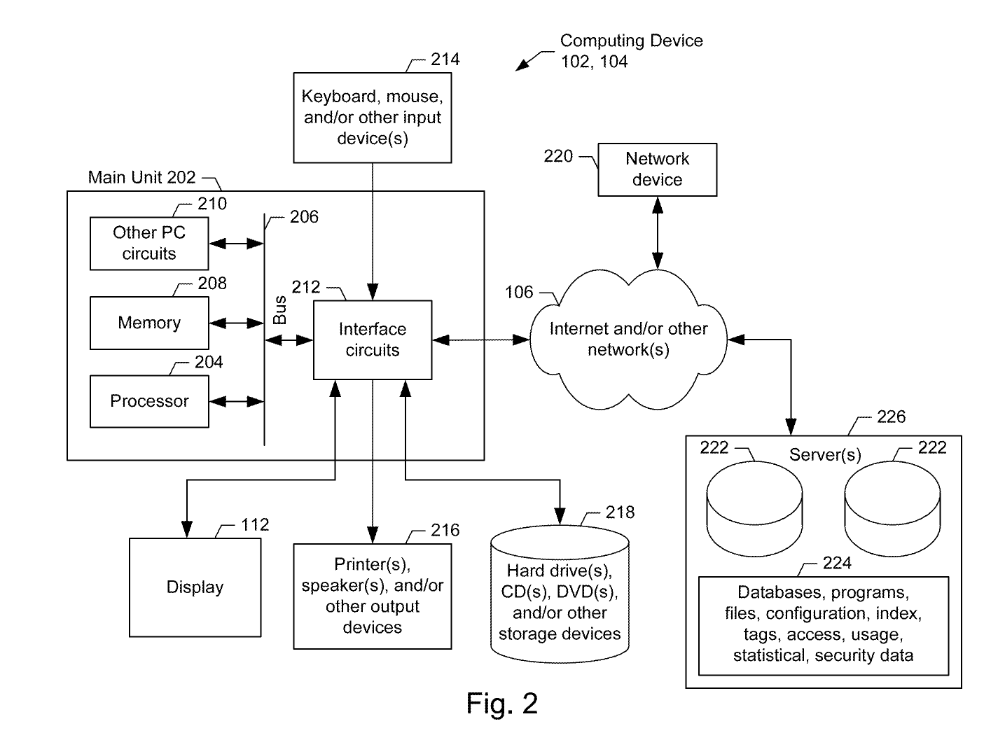

A detailed block diagram of the electrical systems of an example computing device (e.g., a client device 102, and a host device 104) is illustrated in FIG. 2. In this example, the computing device 102, 104 includes a main unit 202 which preferably includes one or more processors 204 electrically coupled by an address/data bus 206 to one or more memory devices 208, other computer circuitry 210, and one or more interface circuits 212. The processor 204 may be any suitable processor, such as a microprocessor from the INTEL PENTIUM® family of microprocessors. The memory 208 preferably includes volatile memory and non-volatile memory. Preferably, the memory 208 stores a software program that interacts with the other devices in the system 100 as described below. This program may be executed by the processor 204 in any suitable manner. In an example embodiment, memory 208 may be part of a “cloud” such that cloud computing may be utilized by a computing devices 102, 104. The memory 208 may also store digital data indicative of documents, files, programs, web pages, etc. retrieved from a computing device 102, 104 and/or loaded via an input device 214.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, track ball, isopoint, image sensor, character recognition, barcode scanner, and/or a voice recognition system.

One or more displays 112, printers, speakers, and/or other output devices 216 may also be connected to the main unit 202 via the interface circuit 212. The display 112 may be a cathode ray tube (CRTs), a liquid crystal display (LCD), or any other type of display. The display 112 generates visual displays generated during operation of the computing device 102, 104. For example, display 112 may provide a user interface, which will be described in further detail below, and may display one or more web pages received from a computing device 102, 104. A user interface may include prompts for human input from a user 114 including links, buttons, tabs, checkboxes, thumbnails, text fields, drop down boxes, etc., and may provide various outputs in response to the user inputs, such as text, still images, videos, audio, and animations.

One or more storage devices 218 may also be connected to the main unit 202 via the interface circuit 212. For example, a hard drive, CD drive, DVD drive, and/or other storage devices may be connected to the main unit 202. The storage devices 218 may store any type of data, such as pricing data, transaction data, operations data, inventory data, commission data, manufacturing data, image data, video data, audio data, tagging data, historical access or usage data, statistical data, security data, etc., which may be used by the computing device 102, 104.

The computing device 102, 104 may also exchange data with other network devices 220 via a connection to the network 106. Network devices 220 may include one or more servers 226, which may be used to store certain types of data, and particularly large volumes of data which may be stored in one or more data repository 222. A server 226 may include any kind of data 224 including databases, programs, files, libraries, pricing data, transaction data, operations data, inventory data, commission data, configuration data, index or tagging data, historical access or usage data, statistical data, security data, etc. A server 226 may store and operate various applications relating to receiving, transmitting, processing, and storing the large volumes of data. It should be appreciated that various configurations of one or more servers 226 may be used to support and maintain the system 100. Also, certain data may be stored in a client device 102 which is also stored on the server 226, either temporarily or permanently, for example in memory 208 or storage device 218. The network connection may be any type of network connection, such as an Ethernet connection, digital subscriber line (DSL), telephone line, coaxial cable, wireless connection, etc.

Access to a computing device 102, 104 can be controlled by appropriate security software or security measures. An individual users' 114 access can be defined by the computing device 102, 104 and limited to certain data and/or actions. Accordingly, users 114 of the system 100 may be required to register with one or more computing devices 102, 104. For example, registered users 114 may be able to request or manipulate data, such as submitting requests for pricing information or providing an offer or a bid.

As noted previously, various options for managing data located within the computing device 102, 104 and/or in a server 226 may be implemented. A management system may manage security of data and accomplish various tasks such as facilitating a data backup process. A management system may be implemented in a client 102, a host device 104, and a server 226. The management system may update, store, and back up data locally and/or remotely. A management system may remotely store data using any suitable method of data transmission, such as via the Internet and/or other networks 106.

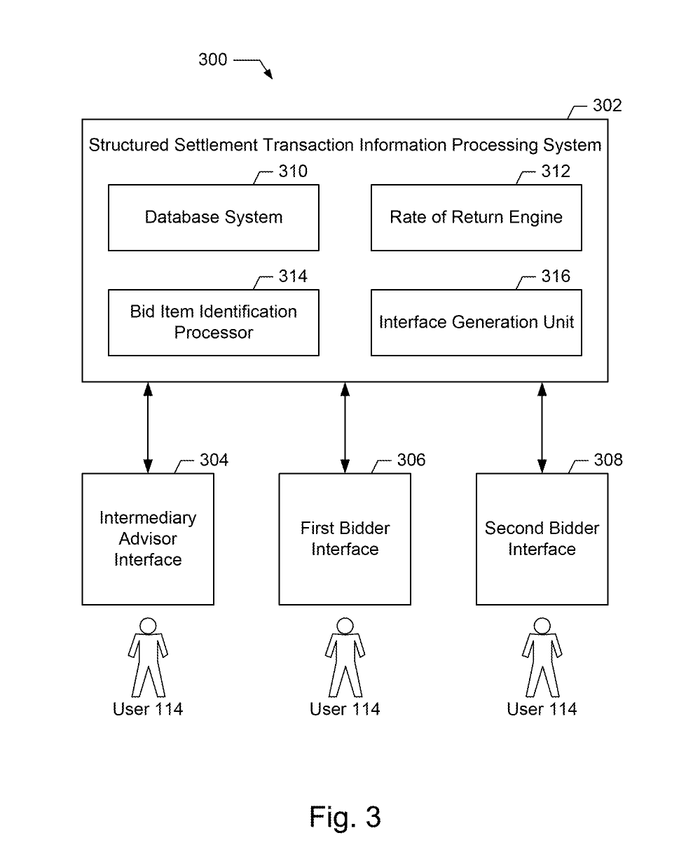

FIG. 3 is a block diagram showing an example transaction network structure 300 which includes structured settlement transaction information processing system 302, intermediary advisor interface 304, first bidder interface 306, and second bidder interface 308. The example structured settlement transaction information processing system 302 may be implemented on one or more host devices 104 accessing one or more servers 108, 226.

In one embodiment, structured settlement transaction information processing system 302 includes database system 310, rate of return engine 312, bid item identification processor 314, and interface generation unit 316. User 114 may be an intermediary advisor, a first bidder, or a second bidder that interacts with intermediary advisor interface 304, first bidder interface 306, or second bidder interface 308, respectively.

Database system 310 may include a wide variety of information regarding structured settlement transaction data which may be used, among other things, to evaluate a current fair market price for a particular structured settlement payment plan.

In one embodiment, rate of return engine 312 is configured to automatically calculate a rate of return for a user. In one embodiment, for each displayed current bid price of a bid item, rate of return engine 312 calculates the rate of return. This calculated rate of return may be displayed next to the current bid price. As new bids are made, rate of return calculator may automatically adjust or update the rate of return based on the new bids.

In one embodiment, rate of return engine 312 enables users (e.g., investors or bidders) to calculate a bidding strategy. A bidding strategy may include a determination of an investor's next bid or maximum bid. For example, for a specific bid time where a bidder desires an eight percent rate of return, rate of return engine 312 may calculate an amount of money the bidder may spend to obtain the desired rate.

In one embodiment, for a specific bid item where a bidder only has a predetermined amount of money to spend, rate of return engine 312 may calculate the rate of return based on the predetermined amount of money.

In one embodiment, for users such potential sellers, intermediary advisors and payment recipients, rate of return engine 312 calculates rates of return for future periodic payments which are not up for auction on structured settlement transaction information processing system 302. For example, if a potential seller has been offered a sum of money to sell a structured settlement, in response to data input by the potential seller, the rate of return engine 312 may calculate a rate of return for that the prospective purchaser would obtain based on the offered sum of money. In anther example, if a potential seller has been offered specific discount rate (e.g. twelve percent), in response to data input by the potential seller, rate of return engine 312 may calculate the amount of money being offered by the potential purchaser.

Bid item identification processor 314 may be configured to enable user 114 to search for bid items. For example, in response to a user search request, bid item identification processor 314 may determine and display bid items based on at least one of the following structured settlement transaction data entered by a user: (a) a user's budget; (b) a user's desired rate of return; (c) payment start date; (d) payment end date; (e) payment amount; (f) cost; (g) whether payments increase over time; (h) aggregate amount of all future payments; (i) current bid; and (j) intermediary advisor data.

In one embodiment, the bid item includes at least one of: (a) a structured settlement; (b) a trust having its sole or major asset a structured settlement; and (c) a company (e.g., an LLC) having its sole or major asset a structured settlement.

In one embodiment, a structured settlement includes an arrangement: (A) which is established by: (i) suit or agreement for the periodic payment of damages; or (ii) agreement for the periodic compensation under any workers' compensation law; and (B) under which the periodic payments are: (i) fixed and determinable as to amount and time of payment; (ii) unable to be accelerated, deferred, increased, or decreased by the recipient of such payments; and (iii) payable by a person who is a party to the suit or agreement or to the workers' compensation claim or by a person who has assumed the liability for such periodic payments under a qualified assignment. In one embodiment, a structured settlement includes an arrangement for periodic payment of compensation for injuries or sickness. In one embodiment, a structured settlement includes an arrangement for periodic payment of benefits under a trust, such as a special needs trust.

In one embodiment, a structured settlement does not include contracts to sell to third-parties, such as settlement contracts, life settlement contracts, life contracts, and viatical contracts. In one embodiment, a structured settlement in not measured by the life of a recipient. In one embodiment, a structured settlement includes a guaranteed number of years. For example, for a structured settlement including monthly payments for fifteen years, a purchaser of the structured settlement will receive guaranteed monthly payments for fifteen years, regardless of whether anyone is alive or dead.

In one embodiment, structured settlement is separate from and does not involve any insurance companies. For example, an uninsured or self-insured defendant may settle a claim for guaranteed future payments.

In one embodiment, a structured settlement is not a financial instrument. For example, a structured settlement may not be considered a financial instrument because the structured settlement may not be liened, or encumbered unless a court finds it in the payee's best interest.

In one embodiment, a structured settlement obligor includes, with respect to any structured settlement, the party that has the continuing obligation to make periodic payments to a payee under a structured settlement agreement or a qualified assignment agreement.

In one embodiment, structured settlement payment rights include rights to receive payments under a structured settlement. In one embodiment, the payments under the structured settlement are received from a structured settlement obligor. In one embodiment, the payments under the structured settlement are received from an annuity issuer. In one embodiment, structured settlement payment rights are not rights in an insurance company. In one embodiment, the structured settlement payment rights are based on a settlement of a personal injury claim wherein the defendant's insurance company obligates itself to render payments over time (and that obligation is typically assigned though a qualified assignment to another institution). In one embodiment, the structured settlement payment rights are based on a court order or judgment arising out of a personal injury lawsuit. In one embodiment, the structured settlement payments are based on a court approved settlement of a minor or incapacitated individual or individuals' claim for personal injuries. In one embodiment, the structured settlement payments represent just a percentage of future payments due to a payee, e.g., one-half of all future payments due to a payee. In one embodiment, the structured settlement payments represent just some of the future payments due to a payee; e.g., none of the next twenty payments, all of the one hundred payments thereafter.

In one embodiment, a structured settlement factoring transaction includes a transfer of structured settlement payment rights (including portions of structured settlement payments) made for consideration by means of sale, assignment, pledge, or other form of encumbrance or alienation for consideration.

In one embodiment, a factoring discount includes an amount equal to the excess of: (A) the aggregate undiscounted amount of structured settlement payments being acquired in the structured settlement factoring transaction; and (B) the total amount actually paid by the acquirer to the person from whom such structured settlement payments are acquired.

In one embodiment, a party must obtain court approval of any contemplated transfer of structured settlement payment rights. A court may approve a transfer of structured settlement payment rights if the court finds the transfer is in the best interest of the payee, taking into account the welfare and support of the payee's dependents.

Where a trust or entity is being sold, the trust/entity enters a transfer agreement with the seller. The transfer agreement may specify that: (a) the seller is transferring specific future payments to the trust/entity; and (b) in return for this transfer, the trust/entity will pay to the seller a sum certain (or a sum certain plus a percentage of proceeds collected from a winning bidder in a subsequent auction). A court may approve this transfer and direct the entity responsible for making the payments to make the payments specified in the transfer agreement to the trust/entity. The entity making those payments acknowledges compliance with the court order either verbally, in writing or by sending the first of the specified payments to the trust/entity and thereafter continue to send all subsequent payments due to the trust/entity to the trust/entity. The trust/entity, including its court approved right to the future payments specified in the transfer agreement, is put up for auction.

Interface generation unit 316 may provide, for example, HTML files which are used at intermediary advisor interface 304, first bidder interface 306, and second bidder interface 308 to provide information to users 114.

It should be appreciated that intermediary advisor interface 304, first bidder interface 306, and second bidder interface 308 may be considered to be part of structured settlement transaction information processing system 302, however, for discussion purposes, intermediary advisor interface 304, first bidder interface 306, and second bidder interface 308 may be referred to as separate from structured settlement information processing system 302.

In one embodiment, intermediary advisor interface 304 enables a user to determine a fair market price for a structured settlement payment plan which the intermediary advisor is interested in selling. For example, using intermediary advisor interface 304, structured settlement transaction information processing system 302 may provide information to the intermediary advisor which indicates a present value of the structured settlement payment plan with a maximum discount rate of twelve percent or eight percent.

In one embodiment, first bidder interface 306 enables a buyer to research items which the buyer is interested in buying. For example, a first bidder may be looking for a structured settlement with specific features (e.g., a maximum cost). In this example, first bidder interface 306 enables the first bidder to input requested and/or desired features.

In one embodiment, in response to a request from bidder interface 304, the structured settlement transaction information processing apparatus 302 may generate reports and cause bidder interface to generate the reports.

In one embodiment, prior to bidding, structured settlement information processing system 302 provides documents which are helpful to potential bidders for performing due diligence. In one embodiment, the documents are provided in response to a selection of a displayed internal or external link. In one embodiment the documents are provided based on an automated email. In one embodiment, these documents are provided only to bidders who meet certain qualifications, e.g., to those bidders who have placed a bid deposit, registered to be a bidder by providing certain data about themselves, or who are on a preferred list of bidders based on prior bid history.

In one example, where a structured settlement transaction is being auctioned prior to court approval, structured settlement information processing system 302 may provide any of the following documents: (a) settlement documents wherein the seller obtained the right to structured settlement payments; (b) a qualified assignment wherein the initial insurer obligated to make the future payments assigned that obligation to the current payment issuer; (c) various documents that would be completed and filed on behalf of the winning bidder to obtain court approval, including a transfer agreement specifying the terms of the transfer, a petition for court approval, the seller's affidavit supporting the petition for court approval, and the proposed court order approving the transfer of the structured settlement payments. These various documents would not contain the amount of the purchase price because that sum would not be known until the conclusion of the auction.

In one example, where a trust or entity that already has the court approved right to structured settlement payments, structured settlement information processing system 302 may provide any of the following documents: (a) settlement documents wherein the seller obtained the right to structured settlement payments; (b) a qualified assignment wherein the initial insurer obligated to make the future payments assigned that obligation to the current payment issuer; (c) court documents used to obtain court approval, including the final order; (d) documents used to create the trust or entity; (e) documents that would be used to transfer all beneficial interest in the trust and that allow the current trustee to resign and appoint a new trustee; and (f) where a company is for sale, the documents that would be used to transfer all ownership interest in the company.

In one example, structured settlement information processing system 302 may provide documents evidencing that the structured settlement payments being auctioned are not encumbered. These documents may include the results of a U.C.C. lien search, a search of all federal/state bankruptcy filings, all state dissolution filings for the seller and assurances from the seller that the payments are free from encumbrances, have not previously been pledged and that the seller has the right and title to transfer the future payment(s).

In one embodiment, structured settlement information processing system 302 may provide information about a company issuing payments. In one embodiment, structured settlement information processing system 302 may provide this information via an internal or external link. For instance, where a first company is issuing the payments, the structured settlement information processing system 302 may provide a link to the first company's web page or otherwise provide bidders information about the first company.

In one embodiment, structured settlement information processing system 302 may provide links to companies who rate the financial strength of the company who must make the payments. In one embodiment, structured settlement information processing system 302 may provide information about how to interpret and understand the financial ranking system, e.g., the site can provide information explaining what an AAA+ rating by a particular company means.

Structured settlement information processing system 302 may process data received by first bidder interface 304, as well as second bidder interface 308 and/or intermediary advisor interface 304, to respond to a request from the first bidder and/or the second bidder. For example, data from database system 310 may be queried for use in a report according to the request and current market data. Structured settlement information processing system 302 may integrate data received from intermediary advisor interface 304, first bidder interface 306, and second bidder interface 308 to provide current and accurate information relating to the market.

In one embodiment, first bidder interface 304 is configured to provide information specific to a factoring company. The structured settlement transaction information processing apparatus 302 enables factoring companies to list and sell their existing inventory. The structured settlement transaction information processing apparatus 302 may enable a factoring company to provide users with a catalog like feature that provides information on different structured settlement related items. For example, a factoring company's website may allow a bidder to select options that are desired for a particular bid item, and may provide price comparisons which intermediary advisors may use for initial research into what pricing a bidder may offer for a particular structured settlement or structured settlement related item.

Accordingly, information may be provided to the structured settlement transaction information processing system 302 from users with a very high degree of granularity, as every structured settlement transaction occurs and or every request or search may be stored and used by the structured settlement transaction information processing system 302. This allows the structured settlement transaction information processing system 302 to use the most current structured settlement transaction data to provide information to users. Market prices can change relatively quickly. Accordingly, reports or other information provided by the structured settlement transaction information processing system 302 may be highly accurate, reliable, and sensitive to market changes.

It should be appreciated that certain functions described as performed, for example, at structured settlement information processing system 302, may instead be performed locally at intermediary advisor interface 304, first bidder interface 306, and second bidder interface 308, or vice versa. It should be appreciated that intermediary advisor interface 304, first bidder interface 306, and second bidder interface 308 may be implemented, for example, in a web browser using an HTML file received from structured settlement transaction information processing system 302. In an example embodiment, intermediary advisor interface 304, first bidder interface 306, and second bidder interface 308 may be located on a website, and may further be implemented as a secure website. Also, intermediary advisor interface 304, first bidder interface 306, and second bidder interface 308 may require a local application, for example, which a factoring company may pay for to have access to, for example, information from structured settlement information processing system 302 such as requests from bidders.

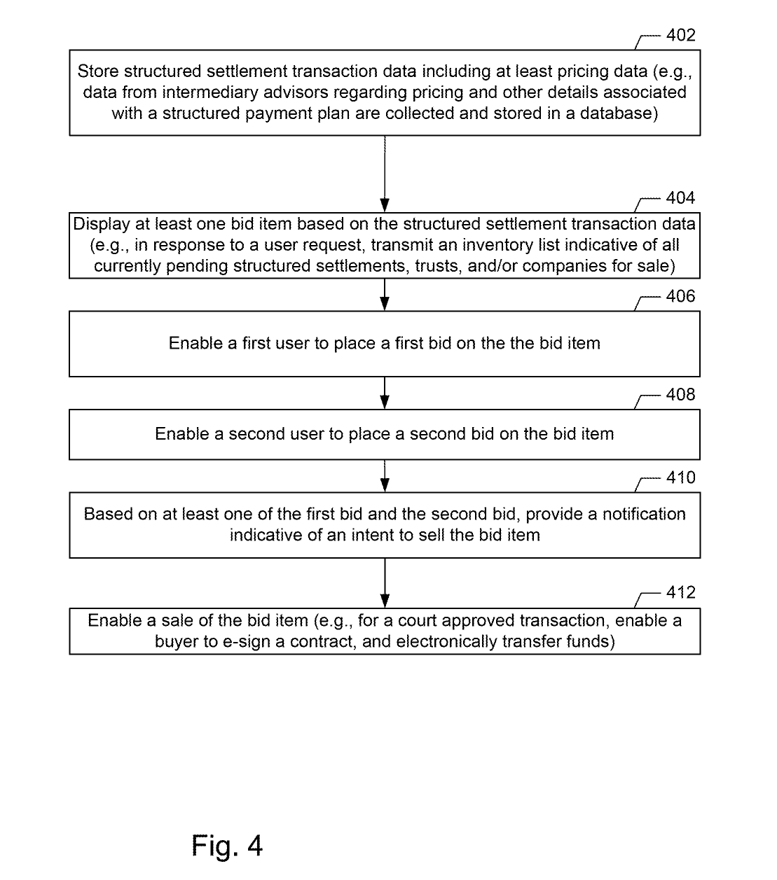

FIG. 4 illustrates one example embodiment of the method of the present disclosure which enables users to conduct structured settlement transactions. The method may enable a seller to receive the highest factoring discount rate available, by enabling users to sell structured settlement payment rights to the highest bidder. In one example, the method may enable a seller to receive the highest factoring discount rate available, by enabling users to sell a trust having its sole asset as a qualified order granting the trust structured settlement payment rights. The method may allow users to efficiently sell and purchase structured settlements and/or structured settlement-related items (e.g., a trust or a company, such as an LLC, having a structured settlement as its sole or major asset). Although the method is described with reference to the flowchart illustrated in FIG. 4, it will be appreciated that many other methods of performing the acts associated with the method may be used. For example, the order of many of the blocks may be changed, certain blocks may be combined with other blocks, and certain of the blocks described are optional.

More specifically, the structured settlement transaction information processing system stores structured settlement transaction data as indicated by block 402. In one example, the structured settlement transaction data is stored in database system 310.

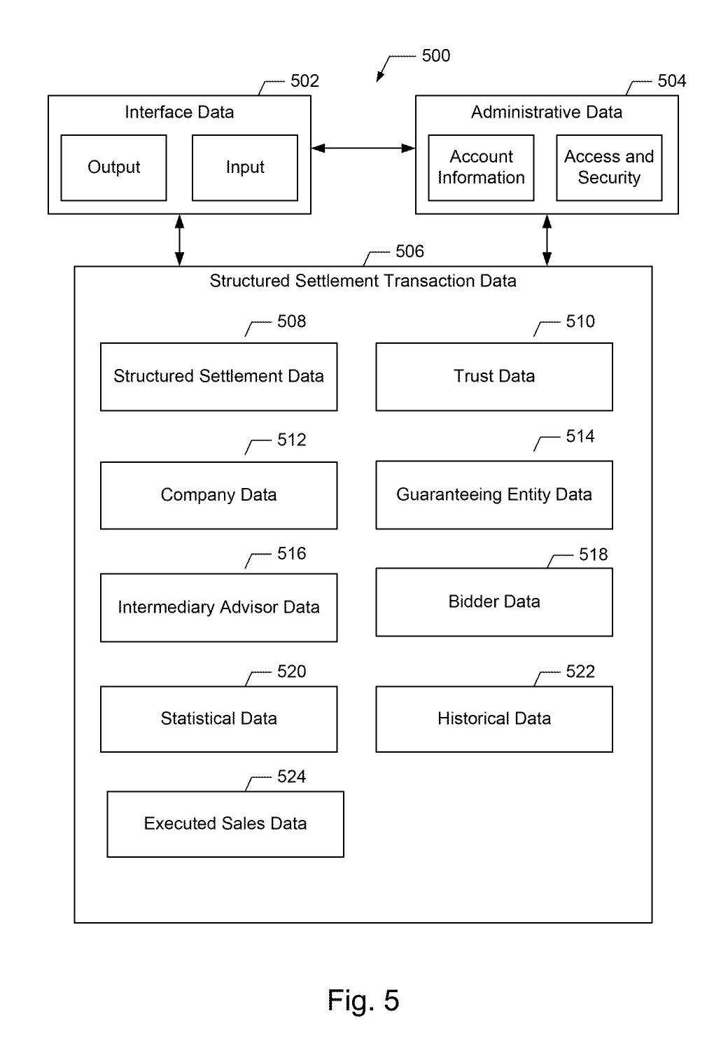

The structured settlement transaction data may include, for example: (a) the date each future payment is due; (b) the amount of each future payment; (c) the aggregate total of all future payments due; (d) the identity of the entity guaranteeing the future payments; (e) ratings of the entity guaranteeing the future payments (e.g., ratings by Standard & Poor's, A.M. Best Company and Moody's); and/or (f) any of the other structured settlement transaction data described herein, such as the structured settlement transaction data identified in FIG. 5.

The structured settlement transaction data may include information collected from first bidder interface 304 and/or second bidder interface 306, such as data indicative of specific searches or requests. The structured settlement transaction data may include information collected from the intermediary advisor interface, such as currently offered pricing, transaction data for finalized sales, current inventory data. The structured settlement transaction data may be comprised solely of information received from intermediary advisor interface 304, first bidder interface 306, and second bidder interface 308, or may include additional information received from other sources.

It should be appreciated that various methods of storing the structured settlement data may be employed according to the system requirements. For example, database system 310 may be organized according to different intermediary advisors, pricing information, factoring companies, and/or specific types of bid items (e.g., structured settlements, trusts and/pr companies whose sole or main asset is a structured settlement). Database system 310 may consist of one or more databases on one or more servers 108, 226 which may be remotely located from each other and/or a host device 104 of the structured settlement transaction information processing system 302. As will be discussed further below, the structured settlement transaction data may be continually updated as new data is provided to structured settlement payment information processing system 302.

As indicated by block 404, the structured settlement transaction information processing apparatus displays at least one bid item based on the structured settlement transaction data. For example, in response to a first bidder inputting a request to view bid items available for purchase, the structured settlement transaction information processing apparatus may cause first bidder interface 306 to display an inventory list of all currently pending structured settlements, trusts, and/or companies for sale.

As indicated by block 406, the structured settlement transaction information processing apparatus enables a first user or bidder to place a first bid on a bid item. For example, the structured settlement transaction information processing apparatus may enable a first bidder to enter a first bid for a structured settlement at the first bidder interface.

As indicated by block 408, the structured settlement transaction information processing apparatus enables a second user or bidder to place a second bid on the bid item. For example, the structured settlement transaction information processing apparatus may enable a second bidder to enter a second bid for the structured settlement which the first bidder has already placed a first bid on.

As indicated by block 410, the structured settlement transaction information processing apparatus provides a notification indicative of intent to sell the bid item based on at least one of the first bid and the second bid. In one embodiment, after a predetermined amount of time occurs, the structured settlement transaction information processing apparatus terminates the bidding process and provides the notification to the bidder who bid the highest price for the bid item. In one embodiment, in response to a received bid price being greater than or equal to a predetermined amount, the structured settlement transaction information processing apparatus terminates the bidding process and provides the notification to the bidder associated with the bid amount placed at or above the predetermined amount.

As indicated by block 412, the structured settlement transaction information processing apparatus may enable a sale of the bid item. For example, in one embodiment, for a court approved transaction, the structured settlement transaction information processing apparatus enables a buyer to e-sign a contract and electronically transfer funds.

It should be appreciated that users may receive significant benefits from the method of facilitating a structured settlement transaction disclosed herein. For example, a payment recipient may receive a higher price for selling his or her payment rights to a structured settlement by utilizing the disclosed system and method. Payment recipients may benefit from more competitive pricing and piece of mind knowing that a fair market price is being offered for prospective purchases.

FIG. 5 illustrates a block diagram of an example data architecture 500. In the example data architecture 500, interface data 502, administrative data 504, and structured settlement payment data 506 interact with each other, for example, based on user commands or requests. Interface data 502, administrative data 504, and structured settlement payment data 506 may be stored on any suitable storage medium (e.g., server 226). It should be appreciated that different types of data may use different data formats, storage mechanisms, etc. Further, various applications may be associated with processing interface data 502, administrative data 504, and structured settlement payment data 506. Various other or different types of data may be included in the example data architecture 500.

Interface data 502 may include input and output data of various kinds. For example, input data may include mouse click data, scrolling data, hover data, keyboard data, touch screen data, voice recognition data, etc., while output data may include image data, text data, video data, audio data, etc. Interface data 502 may include formatting, user interface options, links or access to other websites or applications, and the like. Interface data 502 may include applications used to provide or monitor interface activities and handle input and output data.

Administrative data 504 may include data and applications regarding project data or data related to project compensation. For example, administrative data 504 may include information used for updating accounts, such as creating or modifying intermediary advisor accounts or bidder accounts. Further, administrative data 504 may include access data and/or security data. Administrative data 504 may interact with interface data in various manners, providing a user interface 304, 306, 308 with administrative features, such as implementing a user login and the like.

Structured settlement transaction data 506 may include, for example, structured settlement data 508, trust data 510, company data 512, guaranteeing entity data 514, intermediary advisor data 516, bidder data 518, statistical data 520, historical data 522 and/or executed sales data 524.

Structured settlement data 508 may include at least one of: (a) the date each future payment is due; (b) the amount of each future payment; (c) the aggregate total of all future payments due; (d) the identity of the entity guaranteeing the future payments; and/or (e) ratings of the entity guaranteeing the future payments (e.g., ratings by Standard & Poor's, A.M. Best Company and Moody's).

Trust data 510 may include an indication of whether the beneficial interest in a trust has guaranteed the right to future structured settlement payment or payments. In one example, the indication is evidenced by a court order from a competent jurisdiction.

Company data 512 may include an indication of whether an entity has guaranteed the right to a future structured settlement payment or payments. In one example, the indication is evidence by a court order from a competent jurisdiction. The entity may be any suitable entity such as, for example, a corporation, a limited liability company, limited liability partnership.

Guaranteeing entity data 514 may includes at least one of (a) the identity of the entity guaranteeing the future payments; and (b) ratings of the entity guaranteeing the future payments. The ratings may be provided by companies, such as, for example, Standard & Poor's, A.M. Best Company and Moody's.

Intermediary advisor data 516 may include intermediary advisor pricing, including list prices, negotiation information such as bottom line pricing, offers received, foot traffic activity, and inventory data.

Bidder data 518 may include bidder contact information to be used to notify them of new bid items and for other marketing purposes so as to develop a large bidding community, search activity, bidder requests and offers, bidder feedback, bid history and apparent bid trends, e.g., the type and amount of future payments the bidder prefers, etc.

Statistical data 520 may include information used for providing reports including graphs, forecasts, recommendations, calculators, tax information, etc., including equations and other data used for statistical analysis.

Historical data 522 may include past sales data, such as historical list prices, actual sale prices, service costs or profitability, etc.

Executed sales data 524 may include actual negotiated prices for sales, differences in list prices to negotiated prices, sales demographics, etc.

It should be appreciated that data may fall under multiple categories of structured settlement payment data 506, or change with the passage of time.

It should also be appreciated that structured settlement transaction data 506 may be tailored for a particular intermediary advisor or factoring company, for example, an intermediary advisor may request that a specific type of data that is not normally stored or used be stored in the database system 310. Accordingly, for example, customized reports may be provided to intermediary advisor interface 308 using that specific data for the intermediary advisor.

The integration of the various types of structured settlement transaction data 506 received from intermediary advisor interface 304, first bidder interface 306, and second bidder interface 308 may provide a synergistic and optimal resource for payment recipients, intermediary advisors, purchasers, and/or bidders. The information provided to the bidding interfaces may allow bidders to compete with each other taking into account a greater amount of structured settlement market information, and may allow intermediary advisors to better follow through with opportunities for sales, which may result in a more efficient structured settlement market.

Structured settlement payment data 506 may be maintained in various servers 108, in databases or other files. It should be appreciated that, for example, a host device 104 may manipulate structured settlement payment data 506 in accordance with the administrative data 504 and interface data 502 to provide requests or reports to users 114 including payment recipients, intermediary advisors, and bidders, and perform other associated tasks. It should also be appreciated that structured settlement payment data 506 represents structured settlement payment information, and that these terms may be used interchangeably in this disclosure depending upon the context.

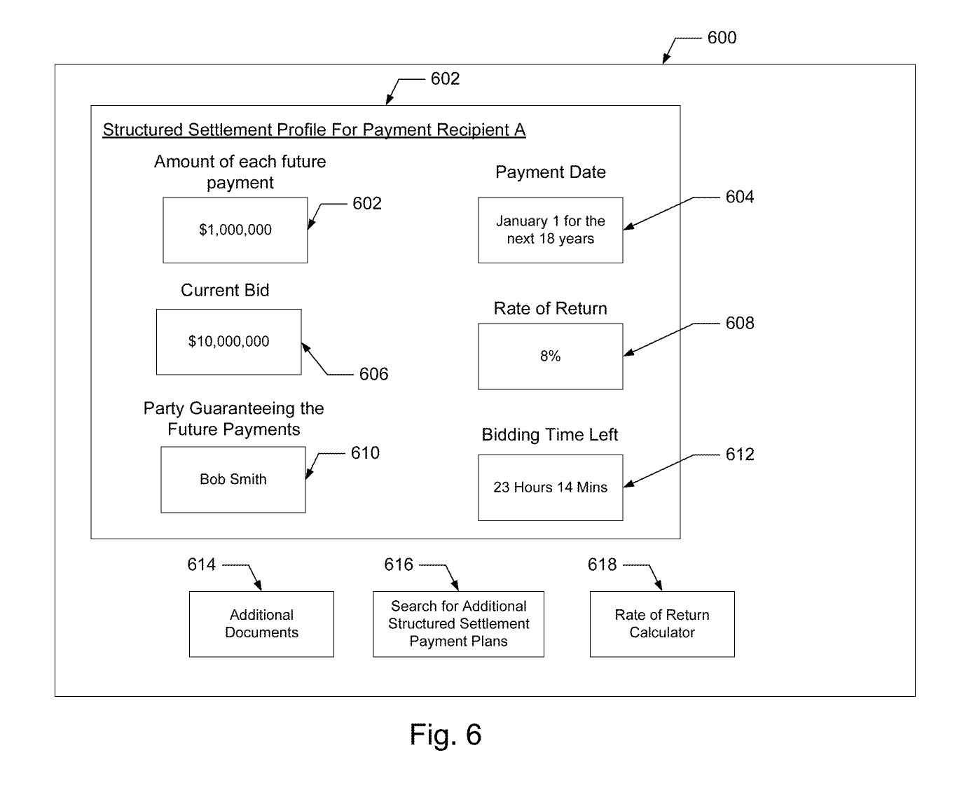

Referring to FIG. 6, this example embodiment generally shows an example illustrating a structured settlement which is for sale and being viewed at a computing device. Display device 600 displays structured settlement profile for payment recipient A 602.

As illustrated in FIG. 6, display device 600 displays the amount of each future payment 604 for the structured settlement owned by payment recipient A. Amount of each future payment 604 shows one million dollars, indicating that the purchaser would receive separate one million dollar payments.

As illustrated in FIG. 6, display device 600 displays the payment date for the structured settlement owned by payment recipient A. The payment date for the structured settlement owned by payment recipient A shows January 1 for the next eighteen years.

Display device 600 displays current bid meter 606 which displays the current bid for the structured settlement owned by payment recipient A. Current bid meter displays ten million dollars, indicating a user has placed a bid for ten million dollars.

Display device 600 displays rate of return meter 608 which displays the rate of return based on the current bid for the structured settlement owned by payment recipient A. Rate of return meter 608 shows eight percent, indicating that the purchaser of the payment rights to the current structured settlement may expect a rate of return of eight percent based on the current bid of ten million dollars.

As illustrated in FIG. 6, display device 600 displays the party guaranteeing the future payments 610 for the structured settlement owned by payment recipient A. The party guaranteeing the future payments 610 for the structured settlement owned by payment recipient A shows “Bob Smith”, indicating that Bob Smith is the guarantor of the future payments.

Display device 600 displays bidding time left meter 608 which displays amount of time left to bid on the structured settlement owned by payment recipient A. Bidding time left meter 608 shows 23 hours and 14 minutes.

Display device 600 includes additional documents button 614. In this example, in response to a selection of additional documents button 614, the structured settlement transaction information processing system displays a plurality of documents, such as: (a) settlement documents wherein the seller obtained the right to structured settlement payments; (b) a qualified assignment wherein the initial insurer obligated to make the future payments assigned that obligation to the current payment issuer; (c) various documents that would be completed and filed on behalf of the winning bidder to obtain court approval, including a transfer agreement specifying the terms of the transfer, a petition for court approval, the seller's affidavit supporting the petition for court approval, and the proposed court order approving the transfer of the structured settlement payments.

Display device 600 includes search for additional structured settlement payment plans button 616. In this example, in response to a selection of search for additional structured settlement payment plans button 616, the structured settlement transaction information processing system enables a user to locate other bid items using input search terms.

Display device 600 includes rate of return calculator button 618. In response to a selection of rate of return calculator button 618, the structured settlement transaction information processing system displays a calculator which enables users to enter data for rate of return and/or discount rate calculations such as those disclosed herein.

It will be appreciated that all of the disclosed methods and procedures described herein can be implemented using one or more computer programs or components. These components may be provided as a series of computer instructions on any conventional computer-readable medium, including RAM, ROM, flash memory, magnetic or optical disks, optical memory, or other storage media. The instructions may be configured to be executed by a processor, which when executing the series of computer instructions performs or facilitates the performance of all or part of the disclosed methods and procedures.

In one example embodiment, a payment recipient may be represented by intermediary advisor. For example, the payment recipient may have a current structured settlement payment plan that pays him one million dollars per year for twenty years. After two years of collecting from the current structured settlement payment plan, the payment recipient may be undergoing a stressful financial situation, and may be in need of a lump sum of money. The payment recipient may decide to sell the current structured settlement payment plan in exchange for a lump sum payment. The payment recipient may then approach an intermediary advisor to ensure a fair price for the current structured settlement payment plan.

The payment recipient may be a beneficiary of an ongoing structured settlement payment plan.

In this example embodiment, the intermediary advisor may prepare a set of legal documents to be presented to a legal authority. The intermediary advisor may present a case to the legal authority arguing that the legal authority should let the payment recipient sell the current structured settlement payment plan in exchange for a lump sum of money. In one embodiment, the intermediary advisory may: (a) assure the court that a potential buyer of the current structured settlement payment plan will be a single asset trust; (b) guarantee that the discount rate on payment recipient's structured settlement plan will not exceed a maximum discount rate; and/or (c) assure the legal authority that the payment recipient may receive a lump sum such that the actual discount rate on the investment is less than the maximum discount rate on the investment by using the structured settlement payment information processing system disclosed herein.

In one embodiment, the payment recipient (e.g. a plaintiff) may have structured settlement payment rights based on an automobile accident. For example, the payment recipient may have been severely injured in an automobile accident caused by another (e.g., a defendant.). In this example, payment recipient may incur medical expenses, hospital charges, emotional distress, and physical pain among other damages. In one embodiment, the payment recipient may have structured settlement payment rights as a beneficiary or an immediate family member of a victim of a car accident caused by another (e.g., a defendant) , and may have had a case for wrongful death, loss of consortium or other legally cognizable claims. In another example, payment recipient may have structured settlement payment rights as a victim of fraud by another who may be have been accused of wrong dealing.

In one embodiment, the payment recipient may have structured settlement payment rights based on an in-court or out-of court settlement. In one example, a plaintiff sues a defendant for negligence and the plaintiff requests compensatory and punitive damages for $500,000.00. In this example, both plaintiff and defendant may go through a costly litigation process before a court, so a plaintiff and defendant may agree to mutually settle to avoid continued court and litigation costs. For example, a plaintiff and a defendant may agree that the present settlement value of the plaintiff's claim is $284,022.57. However, instead of receiving that present-value, lump sum, the parties may agree that the defendant, his/her insurer and or an assignee of his/her insurer will pay $3,000 per month for ten years for a total pay-out of $360,000.00. Plaintiff and defendant may sign a structured settlement agreement memorializing the terms of the settlement.

The defendant, his/her insurance company and or an assignee of his/her insurance company may prefer this arrangement because if he/she/it can earn six percent return on an investment, they could invest $271,571.46 and earn enough to make the $3,000 per month payments to the payment recipient, which is almost an $11,000.00 savings over the $284,022.57 present value of the injury claim.

The plaintiff may prefer this arrangement because under applicable federal and state law, there may be tax advantages to a long term pay-out, the long term pay-out may replace an income stream that the plaintiff lost as a result of the injury and because the plaintiff will, in this case, receive a five percent return on the present value of the claim, i.e., an initial investment of $284,022.57 earning five percent return will pay $3,000 per month for ten years, or $360,000.00.

In this example, plaintiff, now the payment recipient, is scheduled to receive three thousand dollars per month from the defendant's insurance company for ten years. In one example, after the insurance company pays twelve, $3,000.00 monthly payments, the payment recipient may find himself or herself in need of a large sum of money. For instance, the payment recipient may encounter unexpected medical problems or may desire to purchase a home. In this case, the payment recipient may decide to sell the remaining nine years of $3,000 per month payments ($324,000.00 in the aggregate) left in his structured settlement plan in exchange for a lump sum of money.

In one example, after deciding to sell the structured settlement payment plan, the payment recipient may employ an intermediary advisor to assist the payment recipient in obtaining a fair market price for the structured settlement payment plan.

Intermediary advisor may assess payment recipient's reason for selling the structured settlement payment plan. If the intermediary advisor finds that payment recipient's reasons likely to meet with court approval, intermediate advisory may agree to represent the payment recipient in trying to get court approval for the payment recipient to sell the structured settlement payments and then further assist in obtaining a fair market price for them. In exchange, payment recipient may agree to pay the intermediary advisor a fixed, predetermined fee, percentage of the sales price and/or expenses associated with obtaining court approval, selling the future payment(s) and closing the transaction.

It should be appreciated that in instances where a payment recipient is capable and willing to determine an acceptable market price; find a ready, willing and able purchaser at that price and can obtain necessary court approval to sell the structured settlement, an intermediary advisor is not required.

In this example, intermediary advisor and payment recipient agree on a minimum, lump-sum price the payment recipient is willing to accept in exchange for selling the remaining payments. In this example that amount could be, $200,000.00, which is about a twelve percent discount of the $324,000 owed to the payment recipient. In this example, the payment recipient and intermediary advisor agree that if another party were to purchase the payment plan, the intermediary advisor would earn a ten-percent commission plus reimbursement of up to $4,000 to obtain court approval. Accordingly, for the payment recipient to receive $200,000.00, a minimum gross sales price of $224,000.00 would be required.

The intermediary advisor could attempt to find a buyer through the auction process described herein and then seek court approval if one is found. However, in this example, the intermediary advisor creates a trust and causes that trust to enter a transfer agreement with the payment recipient whereby the payment recipient agrees to sell the remaining payments to the trust for $200,000 and pay the intermediary advisor the commission and fees, for a total sales price of $224,000. The transfer agreement further specifies that the intermediary advisor will attempt to sell the trust and its payments for more money and will pay the payment recipient additional money, ninety percent of the additional funds, in this example, if that happens.

At this point, the intermediary advisor could attempt to sell the trust and its contractually secured rights to the future structured settlement plan and obtain court approval after a winning bidder is found. However, in this example, the intermediary advisor prepares a set of legal documents associated with the proposed sale of the structured settlement payment plan to the trust, including a petition seeking approval from a court with jurisdiction over the matter.

In this example, intermediary advisor presents a case to a court or other legal authority and argues that the payment recipient should be allowed to sell the structured settlement payment plan to the trust for $224,000.00, of which the payment recipient will receive $200,000.00, by showing that payment recipient's reasons for selling the structured settlement payment plan and the proposed, net, minimum purchase price of $200,000.00 are in the payment recipient's best interest.

Intermediary advisor may also assure the court that the payment recipient will net more than the minimum purchase price of $200,000.00 if the intermediary advisor can find a purchaser willing to pay a higher price.

In one example, the intermediary advisor could ask the Court to preliminarily approve the transaction, contingent only upon the finding of a winning bidder, as discussed below, willing to pay the minimum, gross sales price of $224,000.00. In that case, at the end of the auction, the winning bidder would agree to pay $224,000.00 or more and the intermediary advisor may collect those funds, return to the court and obtain a final order approving the transaction, pay the original payment recipient $200,000.00 of the money collected from the winning bidder and keep the rest as payment of the agreed upon fees and cost reimbursement.

However, in this example, the court or other legal authority approves the transfer from the payment recipient to the trust for the gross sales price of $224,000.00. In this example, the intermediary advisor may have to or want to purchase the structured settlement plan from the payment recipient for $200,000.00 net to the payment recipient if the intermediary advisor cannot find a winning bidder willing to pay the minimum gross sales price of $224,000.00. The intermediary advisor may be willing to do this because, in this case, $200,000.00 for guaranteed payments of $324,000.00 over the next nine years is a discount rate of around twelve percent and is therefore a fairly lucrative transaction for the intermediary advisor.

In some cases, the payment recipient may be entitled to payment immediately upon court approval. However, in this example, the transfer agreement between the trust and the payment recipient specifies that payment is not due to the payment recipient until sometime after the pending auction occurs and the winning bidder pays at least the amount of the minimum gross sales price of $224,000.00 to the intermediary advisor.

In this example, the intermediary advisor provides a copy of the court order approving the transfer of payments to the trust to the entity responsible for making the future payments and secures from that entity written confirmation that the remaining $3,000.00 monthly payments will be mailed to the trust. That entity could have also acknowledged compliance with the court order by beginning to make the monthly $3,000.00 payments to the trust.

In some examples, the intermediary advisor could have started the auction earlier at numerous stages, either before court approval, upon contingent court approval described above or immediately after court approval of the sales transaction. However, in this example, the intermediary advisor now decides it is time to begin the auction process having received a written court order and confirmation from the entity making the payments that the trust owns and will be receiving the future payment rights.

Because in this example the intermediary advisor has secured the payment rights for a trust, the beneficial interest in the trust, and its rights in the structured settlement payments, can be sold and re-sold, time and time again, without subsequent court approval, thereby making the future payments much more liquid.

The intermediary advisor enters or submits details to the structured settlement transaction information processing apparatus which causes the structured settlement transaction information processing apparatus to store structured settlement payment data including details associated with the structured settlement payment plan.

In this example, because the actual bid item is a trust that owns the right to the structured settlement payments structured as its sole or major asset, the intermediary advisor also enters or submits details to the structured settlement processing apparatus about the trust.

In this example, some of the details entered include that a trust is for sale which has as its sole or major asset, court approved payments of $3,000 per month for nine years totaling $324,000.

In this example, another detail that may be entered is that the minimum bid or reserve price is $224,000.00. This minimum bid or reserve price may or may not be disclosed to the public or qualified bidders.

In this example the structured settlement transaction information apparatus may calculate and publish the discount rate of 8.9043, which is the discount rate at which bidders would obtain the structured settlement plan if they purchased it at the starting price of $224,000.00.

In this example, after each subsequent bid is placed, the structured settlement transaction information apparatus would calculate and publish the updated discount rate for the most current bid. The apparatus my calculate and publish other relevant or common figures in this same manner such as rate of return, return on investment, and nominal discount rate.

In this example, another detail entered is the minimum bid increment of $500.00, i.e., the minimum increase above the minimum bid, reserve price or previous bid that a bidder must bid.

In this example, the structured settlement transaction information processing apparatus publishes or makes available the stored structured settlement payment data, including that amount of each structured settlement payment, the date each such payment is due, the aggregate amount of all future payments, the entity obligated to make those payments and available, commonly recognized ratings of the financial strength and security of that entity.

In this example, the structured settlement transaction information processing apparatus may limit bidding time for the structured settlement payment plan. For example, based on a request from the intermediary advisory, the structured settlement transaction information processing apparatus may limit the bidding time to a period of twenty-four hours. The structured settlement transaction processing apparatus may extend the deadline in various cases.

Thereafter, in this example, the structured settlement transaction information processing apparatus enables users or bidders to view details associated with the structured settlement payment plan.

In one embodiment, the structured settlement transaction information processing apparatus enables a first bidder to bid a minimum price of $224,000.00 for the structured settlement payment plan. In response to a bid of $224,000.00, the structured settlement transaction information processing apparatus may immediately change the minimum bidding price to the next increment, which, in this example, is $500.00 more dollars, or $224,500.00, for all other future bidders. Similarly, the structured settlement transaction information apparatus will automatically update the discount rate, which, in this case would adjust from about 8.9043 percent (the discount rate if paying $224,000.00) to 8.8462 percent (the discount rate if paying $224,500.00).

In one embodiment, a bidder may want to bid based off of rate of return or discount rate. For instance, a bidder may want to place a bid based on a seven percent discount rate. In this example, the structured settlement transaction information processing apparatus will advise the bidder after asking the bidder the desired discount rate, that he/she can place a bid of $241,278.85 or thereabouts, to purchase at a seven percent discount. The bidder may bid that sum or enter it based on the desired discount rate of seven percent, assuming the amount of the resulting bid is higher than the minimum bid at the time.

In one example, the structured settlement transaction information processing apparatus enables an initial, second or subsequent bidder to enter a maximum bidding price. In this example, a subsequent bidder desires to bid a maximum of $275,000.00. In this example, in response to a bidder placing a bid for $275,000.00, the structured settlement transaction information processing apparatus may increase the minimum bidding price to $275,000.00 assuming that bid is higher than the present highest bid. In some examples, if the maximum desired bid is more than one bid increment higher than the present, minimum bid, the structured settlement transaction information processing apparatus may enable the bidder to enter that maximum bid, but will only place the smallest increment allowed for the bidder and will increase the bidder's official bid only if a higher bid is entered by another bidder. The structured settlement transaction information apparatus will continue to increase the bidders bid until the maximum desired bid of $275,000 is reached. .

In another example, the structured settlement transaction information processing apparatus may enable a user to test low bidding prices.

In another example, the structured settlement transaction information processing apparatus may allow the intermediary advisor to register, pre-screen, qualify and secure bid deposits from bidders.

In another example, the structured settlement transaction information processing apparatus may allow the intermediary advisor to refrain from declaring a winning bidder or ending the auction until the intermediary advisor can verify that the winning bidder has funds sufficient to pay for the winning bid.

In one embodiment, the structured settlement transaction information processing apparatus may terminate the bidding process based on a predetermined amount of time lapsing, and declare the highest bidder as the winner. For example, the bidder may be declared the winner of the structured settlement payment plan based on a bid for $276,000.00 made at the expiration of the auction.

In one embodiment, the structured settlement transaction information processing apparatus may terminate the bidding process based on a predetermined amount of money bid For example, the bidder may be declared the winner of the structured settlement payment plan based on a bid for $276,000.00.

In one embodiment, the intermediary advisor may cause itself, a trust or other corporate type entity or the original payment recipient to enter into a contract with the winning bidder such that the winning bidder pays a lump sum of $276,000.00 in exchange for the right to take over a set of remaining payments of the structured settlement payment plan associated with payment recipient. In the current example, the winning bidder may have the right to own the trust, which, in turn, owns the right to collect $3,000.00 per month for nine years, for an aggregate pay-out of $324,000.00.

In one embodiment, the item auctioned may be the right to the structured settlement payments rather than a trust or other entity that owns as its sole or major asset, the court approved right to structured settlement payments. In that embodiment, court approval would not happen until after the auction, In that embodiment, after the auction and after the naming of a winning bidder, the intermediary advisor would prepare documents to petition a court of proper jurisdiction or other legal authority to approve the transfer of structured settlement payment(s) from the payment recipient to the winning bidder for the amount of the winning bid, less any fees, commissions or expenses paid by the payment recipient and/or the winning bidder to the intermediary advisor.

In the current example involving a trust, the intermediary advisor sold the trust/payment plan for $276,000.00 or $52,000.00 more than the minimum selling price of $224,000.00 approved by the court.

In one embodiment, the intermediary advisor may collect from the winning bidder, the amount of the winning bid and any applicable transaction fees charged to the winning bidder, if any.

After a completion of the purchase, the payment recipient may pay the intermediary advisor a predetermined commission price, fee and/or reimbursement of expenses for a set of services rendered.

In one embodiment, the intermediary advisor may close the transaction for the original payment recipient and the winning bidder by collecting money, dispersing net proceeds to the original payment recipient, retaining and fees and expenses due to the intermediary advisor, obtaining any remaining court approval needed, providing the winning bidder signed copies of any documents necessary to transfer the structured settlement payments, trust or entity involved and notifying the entity responsible for making the payments of the transfer, new contact information, change of mailing address for payments and otherwise taking other steps necessary to fully complete the transaction.

In one embodiment, the structured settlement transaction information processing apparatus determines a minimum bidding price of a structured settlement payment plan. The payment recipient may have the right to collect three thousand a month for nine years. However, a current value of the structured settlement payment plan may be a lesser value based on interest that may accumulate over time, inflation and other factors. The structured settlement transaction information processing apparatus may determine a current market value of the structured settlement payment plan based on an amount of principal installment and a remaining time of the structured settlement payment plan. The structured settlement transaction information processing apparatus may determine the minimum bidding price based on the maximum discount rate. For example, in one embodiment, the SSPIPS generates and displays a minimum bidding price of $224,000.00 million based on the maximum discount rate of 8.9 percent.

The following provide Non-Limiting Exemplary Embodiments:
1. A structured settlement transaction information processing system comprising: a processor; and a memory device storing structured settlement transaction data and instructions which when executed by the processor, cause the processor to: using the structured settlement transaction data, cause a bid item to be displayed at a first bidder interface and a second bidder interface; enable a first bidder to place a first bid on the bid item using the first bidder interface, the first bid having a first minimum amount; enable a second bidder to place a second bid on the bid item using the second bidder interface, the second bid having a second minimum amount; and based on at least one of the first bid and the second bid, provide a notification to at least one of the first bidder and the second bidder, the notification being indicative of an intention to sell the bid item.
2. The structured settlement transaction information processing system of Embodiment 0, wherein the bid item is a structured settlement.
3. The structured settlement transaction information processing system of Embodiment 0, wherein the bid item includes a trust which owns a structured settlement.
4. The structured settlement transaction information processing system of Embodiment 0, wherein the bid item includes a company which owns a structured settlement.
5. The structured settlement transaction information processing system of Embodiment 0, 2, 3, or 4 wherein the instructions, when executed by the processor, cause the processor to, after a predetermined amount of time, determine the potential purchaser.
6. The structured settlement transaction information processing system of Embodiment 0, 2, 3, 4 or 5, wherein the instructions, when executed by the processor, cause the processor to: determine whether the first bid is at least equal to a predetermined amount; and in response to the first bid being at least equal to the predetermined amount, provide the first notification to the first bidder.
7. The structured settlement transaction information processing system of Embodiment 0, 2, 3, 4, 5 or 6 wherein the instructions, when executed by the processor, cause the processor to: automatically determine a discount rate or rate of return based on a current bid price of the bid item; and (b) display the determined discount rate or rate of return.
8. The structured settlement transaction information processing system of Embodiment 0, 2, 3, 4, 5, 6 or 7, wherein the instructions, when executed by the processor, cause the processor to enable those who own the rights to one or more structured settlement plans to list an inventory of bid items using an online store.
9. A method of operating a structured settlement transaction information processing system, the method comprising: causing a processor to execute instructions to, using structured settlement transaction data, cause a bid item to be displayed at a first bidder interface and a second bidder interface; causing the processor to execute the instructions to enable a first bidder to place a first bid on the bid item using the first bidder interface, the first bid having a first minimum amount; causing the processor to execute the instructions to enable a second bidder to place a second bid on the bid item using the second bidder interface, the second bid having a second minimum amount; and causing the processor to execute the instructions to, based on at least one of the first bid and the second bid, provide a notification to at least one of the first bidder and the second bidder, the notification being indicative of an intention to sell the bid item.
10. The method of Embodiment 0, wherein the bid item includes a structured settlement.
11. The method of Embodiment 0, wherein the bid item includes a trust which owns a structured settlement.
12. The method of Embodiment 0, wherein the bid item includes a company which owns a structured settlement.
13. The method of Embodiment 0, 10, 11 or 12, which includes causing the processor to execute the instructions to, after a predetermined amount of time, determine the potential purchaser.
14. The method of Embodiment 0, 10, 11, 12 or 13, which includes: causing the processor to execute the instructions to determine whether the first bid is at least equal to a predetermined amount; and causing the processor to execute the instructions to in response to the first bid being at least equal to the predetermined amount, provide the first notification to the first bidder.
15. The method of Embodiment 0, 10, 11, 12, 13 or 14, which includes: causing the processor to execute the instructions to automatically determine a rate of return based on a current bid price of the bid item; and which includes causing the processor execute the instructions to operate with a display device to display the determined rate of return.
16. The method of Embodiment 0, 10, 11, 12, 13, 14 or 15, which includes causing the processor to execute the instructions to enable those who own the rights to one or more structured settlement plans to list an inventory of bid items using an online store.
17. A non-transitory computer readable medium storing instructions structured to cause an information processing apparatus to: using structured settlement transaction data, cause a bid item to be displayed at a first bidder interface and a second bidder interface; enable a first bidder to place a first bid on the bid item using the first bidder interface, the first bid having a first minimum amount; enable a second bidder to place a second bid on the bid item using the second bidder interface, the second bid having a second minimum amount; and based on at least one of the first bid and the second bid, provide a notification to at least one of the first bidder and the second bidder, the notification being indicative of an intention to sell the bid item.
18. The non-transitory computer readable medium of Embodiment 0, wherein the bid item includes a structured settlement.
19. The non-transitory computer readable medium of Embodiment 0, wherein the bid item includes a trust which owns a structured settlement.
20. The non-transitory computer readable medium of Embodiment 0, wherein the bid item includes a company which owns a structured settlement.

In certain embodiments the structured settlement is the sole asset or only major asset of the trust or company.

Unless otherwise indicated, all numbers expressing quantities, such as discount rates and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. It is anticipated that one or more members of a group can be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Specific embodiments disclosed herein can be further limited in the claims using consisting of or and consisting essentially of language. When used in the claims, whether as filed or added per amendment, the transition term “consisting of” excludes any element, step, or ingredient not specified in the claims. The transition term “consisting essentially of” limits the scope of a claim to the specified materials or steps and those that do not materially affect the basic and novel characteristic(s). Embodiments of the invention so claimed are inherently or expressly described and enabled herein.

In closing, it is to be understood that the embodiments of the invention disclosed herein are illustrative of the principles of the present invention. Other modifications that can be employed are within the scope of the invention. Thus, by way of example, but not of limitation, alternative configurations of the present invention can be utilized in accordance with the teachings herein. Accordingly, the present invention is not limited to that precisely as shown and described.

The invention is claimed as follows:

1. A structured settlement transaction information processing system comprising:
a processor; and
a memory device storing structured settlement transaction data and instructions which when executed by the processor, cause the processor to:
(a) using the structured settlement transaction data, cause a bid item to be displayed at a first bidder interface and a second bidder interface;
(b) enable a first bidder to place a first bid on the bid item using the first bidder interface, the first bid having a first minimum amount;
(c) enable a second bidder to place a second bid on the bid item using the second bidder interface, the second bid having a second minimum amount; and
(d) based on at least one of the first bid and the second bid, provide a notification to at least one of the first bidder and the second bidder, the notification being indicative of an intention to sell the bid item.

2. The structured settlement transaction information processing system of claim 1, wherein the bid item includes a structured settlement.

3. The structured settlement transaction information processing system of claim 1, wherein the bid item includes a trust which includes a structured settlement.

4. The structured settlement transaction information processing system of claim 1, wherein the bid item includes a company which includes a structured settlement.

5. The structured settlement transaction information processing system of claim 1, wherein the instructions, when executed by the processor, cause the processor to, after a predetermined amount of time, determine the potential purchaser.

6. The structured settlement transaction information processing system of claim 1, wherein the instructions, when executed by the processor, cause the processor to:
(a) determine whether the first bid is at least equal to a predetermined amount; and
(b) in response to the first bid being at least equal to the predetermined amount, provide the first notification to the first bidder.

7. The structured settlement transaction information processing system of claim 1, wherein the instructions, when executed by the processor, cause the processor to:
(a) automatically determine a discount rate or rate of return based on a current bid price of the bid item; and
(b) display the determined discount rate or rate of return.

8. The structured settlement transaction information processing system of claim 1, wherein the instructions, when executed by the processor, cause the processor to enable those who own the right to one or more structured settlement plans to list an inventory of bid items using an online store.

9. A method of operating a structured settlement transaction information processing system, the method comprising:
(a) causing a processor to execute instructions to, using structured settlement transaction data, cause a bid item to be displayed at a first bidder interface and a second bidder interface;
(b) causing the processor to execute the instructions to enable a first bidder to place a first bid on the bid item using the first bidder interface, the first bid having a first minimum amount;
(c) causing the processor to execute the instructions to enable a second bidder to place a second bid on the bid item using the second bidder interface, the second bid having a second minimum amount; and
(d) causing the processor to execute the instructions to, based on at least one of the first bid and the second bid, provide a notification to at least one of the first bidder and the second bidder, the notification being indicative of an intention to sell the bid item.

10. The method of claim 9, wherein the bid item includes a structured settlement.

11. The method of claim 9, wherein the bid item includes a trust which includes a structured settlement.

12. The method of claim 9, wherein the bid item includes a company which includes a structured settlement.

13. The method of claim 9, which includes causing the processor to execute the instructions to, after a predetermined amount of time, determine the potential purchaser.

14. The method of claim 9, which includes:
(a) causing the processor to execute the instructions to determine whether the first bid is at least equal to a predetermined amount; and
(b) causing the processor to execute the instructions to in response to the first bid being at least equal to the predetermined amount, provide the first notification to the first bidder.

15. The method of claim 9, which includes:
(a) causing the processor to execute the instructions to automatically determine a rate of return based on a current bid price of the bid item; and
(b) which includes causing the processor execute the instructions to operate with a display device to display the determined rate of return.

16. The method of claim 9, which includes causing the processor to execute the instructions to enable those who own the right to one or more structured settlement plans to list an inventory of bid items using an online store.

17. A non-transitory computer readable medium storing instructions structured to cause an information processing apparatus to:
(a) using structured settlement transaction data, cause a bid item to be displayed at a first bidder interface and a second bidder interface;
(b) enable a first bidder to place a first bid on the bid item using the first bidder interface, the first bid having a first minimum amount;
(c) enable a second bidder to place a second bid on the bid item using the second bidder interface, the second bid having a second minimum amount; and
(d) based on at least one of the first bid and the second bid, provide a notification to at least one of the first bidder and the second bidder, the notification being indicative of an intention to sell the bid item.

18. The non-transitory computer readable medium of claim 17, wherein the bid item includes a structured settlement.

19. The non-transitory computer readable medium of claim 17, wherein the bid item includes a trust which includes a structured settlement.

20. The non-transitory computer readable medium of claim 17, wherein the bid item includes a company which includes a structured settlement.
